(19) United States
(12) Patent Application Publication
(10) Pub. No.: US 2025/0029064 A1
(43) Pub. Date: Jan. 23, 2025

(54) SYSTEMS AND METHODS TO AUTOMATE GLOBAL EMPLOYMENT

(71) Applicant: OYSTER HR, INC., Wilmington, DE (US)

(72) Inventors: Michael MCCORMICK, Boulder, CO (US); Samuel Gomes Brandao, Sao Paulo (BR); Guilherme Marques Pecanha Araujo, Belo Horizonte (BR); Nick Schultz, Waterford, PA (US); Andre Bastos, Aveiro (PT); Charlotte Bory, Paris (FR); Dan Lucraft, Greater London (GB)

(73) Assignee: OYSTER HR, INC., Wilmington, DE (US)

(21) Appl. No.: 18/765,923

(22) Filed: Jul. 8, 2024

Related U.S. Application Data
(60) Provisional application No. 63/514,630, filed on Jul. 20, 2023.

(51) Int. Cl. G06Q 10/1053

(52) U.S. Cl. CPC G06Q 10/1053

(57) ABSTRACT

Systems and methods to automate global employment are disclosed. A method may include generating a decision tree comprising one or more nodes. The method may include receiving a selection related to an employment inquiry. The method may include receiving a selection of a geographical preference associated with the employment inquiry. The method may include modifying the decision tree such that the one or more nodes are limited to a subset of nodes related to the employment inquiry and the geographical preference. The method may include receiving a selection of a preferred node of the subset of nodes. The method may include modifying the decision tree such that the decision tree is limited to the preferred node and a corresponding at least one branch.

### CROSS-REFERENCE TO RELATED APPLICATIONS

The present disclosure claims priority to U.S. Provisional Patent Application No. 63/514,630 entitled SYSTEMS AND METHODS TO AUTOMATE GLOBAL EMPLOYMENT filed on Jul. 20, 2023, the contents of which are hereby incorporated by reference in its entirety.

### BACKGROUND

Software as a Service (SaaS) platforms have dramatically transformed the landscape of digital services making software more accessible and affordable, however despite these advantages, there are certain limitations and drawbacks particularly when conventional platforms use manual coding and imperative approaches to provide regulatory services.

For example, manual coding requires significant development time and expertise both of which add to the cost of the software as a service solution. Moreover, code written manually is prone to human error particularly potentially leading to system vulnerabilities and software defects; these issues can cause functionality problems, security breaches or non-compliance with regulations which can be particularly critical when dealing with regulatory solutions.

Further, imperative programming is a coding approach that focuses on how a program operates, i.e., explicitly coded for each sequence of steps needed to reach a result or solution. In the context of SaaS platforms providing regulatory solutions, utilizing, and maintaining an imperative programming model could be particularly challenging, since regulatory environments are complex and subject to frequent changes. Indeed, imperative coding involves detailing each step in the logic and control flow of the software; if a regulatory law changes the programmer must identify all the relevant parts of the code, understand how they interact with changed law and modify the code accordingly. As one having skill in the art can appreciate, this process is labor intensive, error prone, and time consuming. Moreover, the necessity for regular manual updates increases the likelihood of inconsistencies and introduces delays between regulatory change and system updates, thereby increasing compliance risk.

Furthermore, SaaS solutions using imperative programming may lack flexibility and adaptability. Given the rigid control flows these solutions may not easily accommodate user specific customizations or new regulations. This inflexibility can limit the utility of the software for end users and decrease overall user satisfaction.

Accordingly, there is a need for systems and methods that address the deficiencies of these conventional approaches.

### SUMMARY

The instant system and methods provide improvements and solutions to the known limitations and deficiencies discussed above. The disclosed solution implements a declarative approach to providing a system to automate global employment (SAGE) via a platform with dimensionality, depth, breadth, and dynamism.

In one non-limiting embodiment, the SAGE platform maintains a declarative description of employment laws that enable the automated customization of our platform based on the country where a customer wants to hire. This automated customization includes textual guidance, web forms generation, and validation rules. Given the declarative approach, to add support for a new country, or to update our platform to comply with new employment rules, it is enough to update the values in SAGE, without the need to write or update source code. This is fundamentally different from conventional platforms that implement an imperative approach by hard coding each country's country-specific logic.

In another non-limiting embodiment the instant solution may include system(s), computer-implemented method(s), and non-transitory computer-readable medium(s) for: generating a decision tree comprising one or more nodes; receiving a selection related to an employment inquiry; receiving a selection of a geographical preference associated with the employment inquiry; modifying the decision tree such that the one or more nodes are limited to a subset of nodes related to the employment inquiry and the geographical preference; receiving a selection of a preferred node of the subset of nodes; and modifying the decision tree such that the decision tree is limited to the preferred node and a corresponding at least one branch.

The instant solution may include a declarative knowledge base configured to receive data input via decision table. Additionally, the instant solution may further include a declarative application programming interface.

### BRIEF DESCRIPTION OF THE FIGURES

FIG. 1 depicts an exemplary system for automated global employment according to an embodiment of the present disclosure.

FIG. 2 depicts an exemplary method for generating a decision tree according to an embodiment of the present disclosure.

FIG. 3 depicts an exemplary dynamic dashboard for a decision tree according to an embodiment of the present disclosure.

FIG. 4 depicts an exemplary dynamic dashboard for a declarative knowledge base according to an embodiment of the present disclosure.

FIG. 5 depicts an exemplary computing device according to an embodiment of the present disclosure.

### DETAILED DESCRIPTION OF SEVERAL EMBODIMENTS

Embodiments of the present disclosure relate to systems and methods for a novel automated global employment platform that is configured to maintain and provide information related to global statutory and customary practices. The automated global employment platform may further be configured to implement automated workflows related to employee: hiring, pay, care, and offboarding; and automated workflows for accessing and updating global statutory and customary knowledge and data.

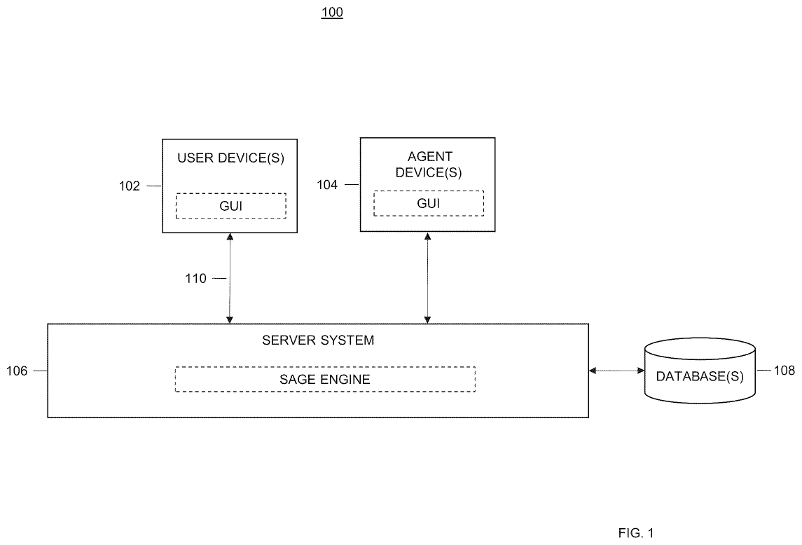

Referring to FIG. 1, computing environment 100 can be configured to host a SAGE platform, according to embodiments of the present disclosure. Computing environment 100 may include one or more user device(s) 102, one or more agent device(s) 104, a server system 106, and one or more database(s) 108, communicatively coupled to the server system 106. The user device(s) 102, agent device(s) 104, server system 106, and database(s) 108 may be configured to communicate through network 110.

In one or more embodiments, user device(s) 102 is operated by a user. Users may include, but are not limited to, entities such as, individuals, companies, prospective clients, customers, or new hire employees of customers of an entity associated with server system 106, such as companies utilizing the services of, or consultation from, an entity associated with that document and server system 106.

User device(s) 102 according to the present disclosure may include, without limit, any combination of mobile phones, smart phones, tablet computers, laptop computers, desktop computers, server computers or any other computing device configured to capture, receive, store and/or disseminate any suitable data. In one embodiment, a user device(s) 102 includes a non-transitory memory, one or more processors including machine readable instructions, a communications interface which may be used to communicate with the server system (and, in some examples, with the database(s) 108), a user input interface for inputting data and/or information to the user device and/or a user display interface for presenting data and/or information on the user device. In some embodiments, the user input interface and the user display interface are configured as an interactive graphical user interface (GUI). The user device(s) 102 are also configured to provide the server system 106, via the interactive GUI, input information such as user actions (e.g., queries, media, text, and/or documents) for further processing. In some embodiments, the interactive GUI is hosted by the server system 106 or provided via a client application operating on the user device. In some embodiments, a user operating the user device(s) 102 may query server system 106 for information related to a service provided by an entity hosting server system 106.

In one or more embodiments, each agent device(s) 104 is operated by a user under the supervision of the entity hosting and/or managing server system 106. Agent device(s) 104 may be representative of a mobile device, a tablet, a desktop computer, or any computing system having the capabilities described herein. Users of the agent device(s) 104 include, but are not limited to, individuals such as, for example, software engineers, database administrators, employees, and/or customer service agents, of an entity associated with server system 106.

Agent device(s) 104 according to the present disclosure include, without limit, any combination of mobile phones, smart phones, tablet computers, laptop computers, desktop computers, server computers or any other computing device configured to capture, receive, store and/or disseminate any suitable data. In one embodiment, each agent device(s) 104 includes a non-transitory memory, one or more processors including machine readable instructions, a communications interface that may be used to communicate with the server system (and, in some examples, with database(s) 108), a user input interface for inputting data and/or information to the user device and/or a user display interface for presenting data and/or information on the user device. In some examples, the user input interface and the user display interface are configured as an interactive GUI. The agent device(s) 104 are also configured to provide the server system 106, via the interactive GUI, input information (e.g., queries or new data values) for further processing. In some examples, the interactive GUI may be hosted by the server system 106 or it may be provided via a client application operating on the user device.

In some embodiments, the server system 106 includes one or more processors, servers, databases, communication/traffic routers, non-transitory memory, modules, and interface components. In one or more embodiments, server system 106 hosts, stores, and operates a dynamic dashboard to implement decision tree processes. Server system 106 may be configured for generating a decision tree comprising one or more nodes, receiving a selection related to an employment inquiry, and receiving a selection of a geographical preference associated with the employment inquiry. Server system 106 may be further configured for modifying the decision tree such that the one or more nodes are limited to a subset of nodes related to the employment inquiry and the geographical preference. Server system 106 may further receive a selection of a preferred node of the subset of nodes and modify the decision tree such that the decision tree is limited to the preferred node and a corresponding at least one branch.

Moreover, the server system 106 may include security components capable of monitoring user rights and privileges associated with initiating API requests (e.g., declarative APIs) for accessing the server system 106 and modifying data in database(s) 108. Accordingly, the server system 106 may be configured to manage user rights, manage access permissions, object permissions, and the like. The server system 106 may be further configured to implement two-factor authentication, secure sockets layer (SSL) protocols for encrypted communication sessions, biometric authentication, and token-based authentication.

Database(s) 108 may be locally managed, and/or may be a cloud-based collection of organized data stored across one or more storage devices. Database(s) 108 may be complex and developed using one or more design schema and modeling techniques. Database(s) 108 may be hosted at one or more data centers operated by a cloud computing service provider. Database(s) 108 may be geographically proximal to or remote from the server system 106 and is configured for data dictionary management, data storage management, multi-user access control, data integrity, backup and recovery management, database access language application programming interface (API) management, and the like. Database(s) 108 is in communication with server system 106, end user device(s) 102, and agent device(s) 104, via network 110. Database(s) 108 store various data, including workflow and employment data, employment data, regulatory information, geographical data, that can be modified and leveraged by server system 106, user device(s) 102, and agent device(s) 104. Various data in the database(s) 108 will be refined over time using a dynamic dashboard. In conjunction with the dynamic dashboard and/or other computer environment 100 components. Additionally, database(s) 108 may be deployed and maintained automatically by one or more components shown in FIG. 1.

Network 110 may be of any suitable type, including individual connections via the Internet, cellular or Wi-Fi networks. In some embodiments, network 110 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, LAN, or the Internet. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

In some embodiments, communication between the elements may be facilitated by one or more application programming interfaces (APIs). APIs of server system 106 may be proprietary and/or may be examples available to those of ordinary skill in the art such as Amazon® Web Services (AWS) APIs or the like.

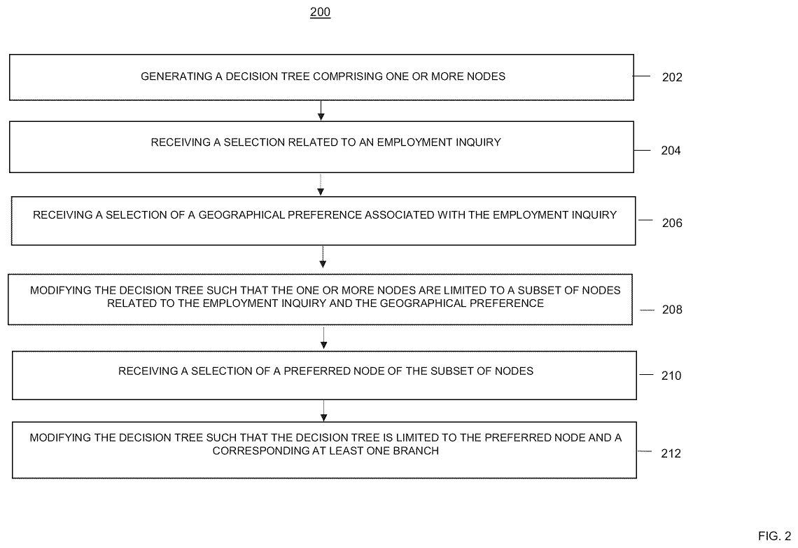

FIG. 2 depicts an exemplary method 200 for generating a decision tree according to an embodiment of the present disclosure. Employment-related decision trees may be generated in furtherance of one or more employment related processes.

At 202, server system 106 may generate a decision tree comprising one or more nodes. For example, in furtherance of providing SAGE server system 106 may initially generate and maintain a decision tree that is visually depicted to a user operating user device(s) 102 or agent device(s) 104. The decision tree may include one or more nodes related to various topics. Further, each node may have a corresponding branch that leads downstream to a node that is a sub-topic or sub-characteristic of the node upstream parent node.

At 204, server system 106, may receive a selection related to an employment inquiry. Here, the user may make a selection from a menu or a set of options (i.e., employment topics) and/or type a topic into a field, related to a topic that the user desires to receive additional information about. For example, a user operating user device(s) 102 selection requesting employment probation period information (from a list including additional employment related topics) via a dashboard.

At 206, server system 106, may receive a selection of a geographical preference associated with the employment inquiry. Here, in addition to making a selection related to an employment inquiry as in 204, a user may select a geographical region that narrows the topic of the employment inquiry to a specific region (e.g., including but not limited to a country, state, city, and/or territory). For example, a user operating user device(s) 102 may select a specific country (i.e., France) that they desire to specifically receive employment probation period information about.

At 208, server system 106, may modify the decision tree such that the one or more nodes are limited to a subset of nodes related to the employment inquiry and the geographical preference. Here, server system 106 may modify the decision tree responsive to the selections at 204 and 206. For example, the server system 106 may refine the nodes in the decision tree from displaying all possible nodes to displaying a subset of nodes specifically related to employment probation period information in the country of France.

At 210, server system 106, may receive a selection of a preferred node of the subset of nodes. Here, server system 106 may receive a selection of a node that is sub-topic or a sub-characteristic presented to the user subsequent to the decision tree being refined. For example, a user may select a node related to a type of employee (e.g., a permanent or a temporary employee) that the user desires to receive employment probation information about in France.

At 212, server system 106, may modify the decision tree such that the decision tree is limited to the preferred node and a corresponding at least one branch. Here, the server system 106 may further refine the decision tree based on a selection of a specific preferred node (i.e., a sub-topic or sub-characteristic). The preferred node may display as highlighted and each branch that extends from the preferred node may further be highlighted. The decision tree may further be modified to remove or grey out unrelated nodes and branches. For example, in response to receiving a selection related to the preferred node (e.g., a selection of a node related to a type of employee to receive employment probation period information in France for), the server system 106 may highlight the preferred node and remove/grey out non-selected nodes. Further, employment regulatory information related to the preferred node may be displayed to the user. For example, employment probation period information related to a temporary or permanent employee in France may be displayed via the dashboard.

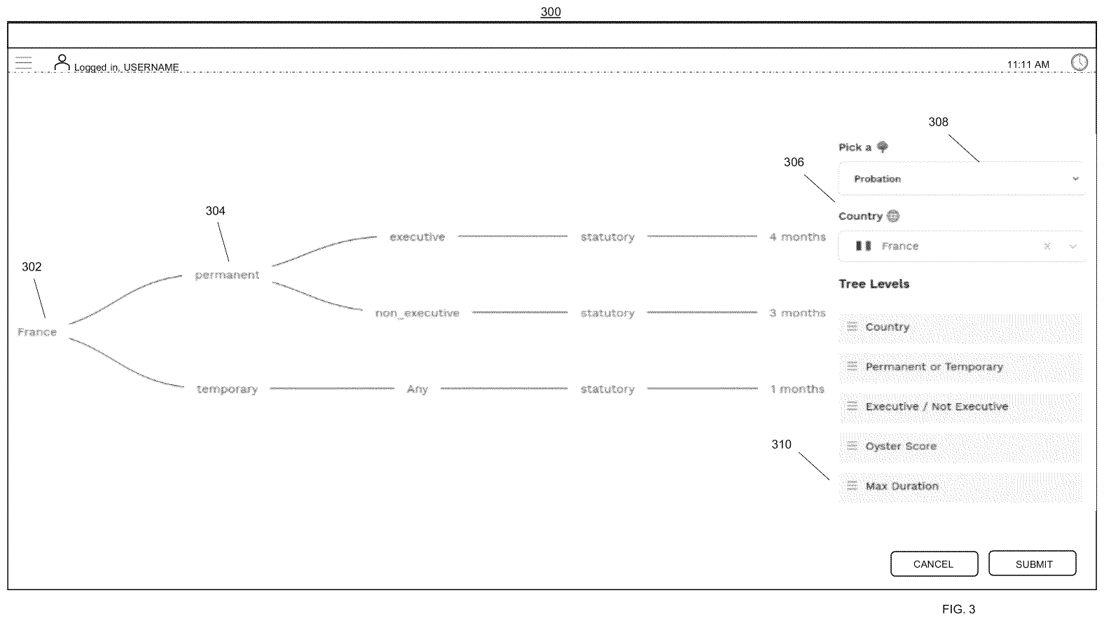

FIG. 3 depicts an exemplary dynamic dashboard for a decision tree 300 according to an embodiment of the present disclosure. As explained in relation to FIG. 2, server system 106, may host and maintain a SAGE platform comprising a dynamic dashboard configured to display a decision tree. In a non-limiting example, the dynamic dashboard for a decision tree 300 may be a private or publicly available employment comparison tool that interacts with an API that aggregates data as ranges or sets of possible values. The dynamic dashboard for a decision tree 300 may include one or more interactive nodes. These interactive nodes may be clickable, thereby causing the decision tree to become more refined to reveal more or fewer nodes and/or other specific details regarding the node that is selected. As depicted in FIG. 3, there may be a first node 302 related to a geographic preference and a second node 304 related to an employment type. The decision tree may be dynamically refined to display the first node 302 and consequently the second node 304 based on selections of a geographical preference 306 and employment inquiry 308. For example, a user selection of a geographical preference 306 may cause the decision tree to limit the subset of nodes that are displayed to nodes that branch off from first node 302 (e.g., nodes with branches related to France). Notably, geographical preference 306 and employment inquiry 308 are representative topics and other topics may be substituted. In addition, geographical preference 306 and employment inquiry 308 may be used as prompts by the dynamic dashboard for a decision tree 300 to request that the user provide the necessary information to generate a decision tree that is responsive to the user's inquiry.

Similarly, a user selection of an employment inquiry 308 may cause the decision tree to limit the subset of nodes that are displayed to nodes that branch of from the selection of the second node 304 (e.g., permanent, or temporary employment types). Further, tree level categories 310 may be adjusted (e.g., drag/dropped and/or re-ranked) to reorganize how a dataset is displayed. For example, dragging the max duration option to the top of the tree level categories 310 may cause the server system 106 to automatically modify the decision tree in real time such that the dataset is dynamically rearranged to prioritize the display of countries and employment types based on the maximum duration of their probation periods. These 3 perspectives could be displayed side by side, offering a real time view of the prose that will be generated for review, and rapid feedback for rule editors, with each step reducing the likelihood of errors.

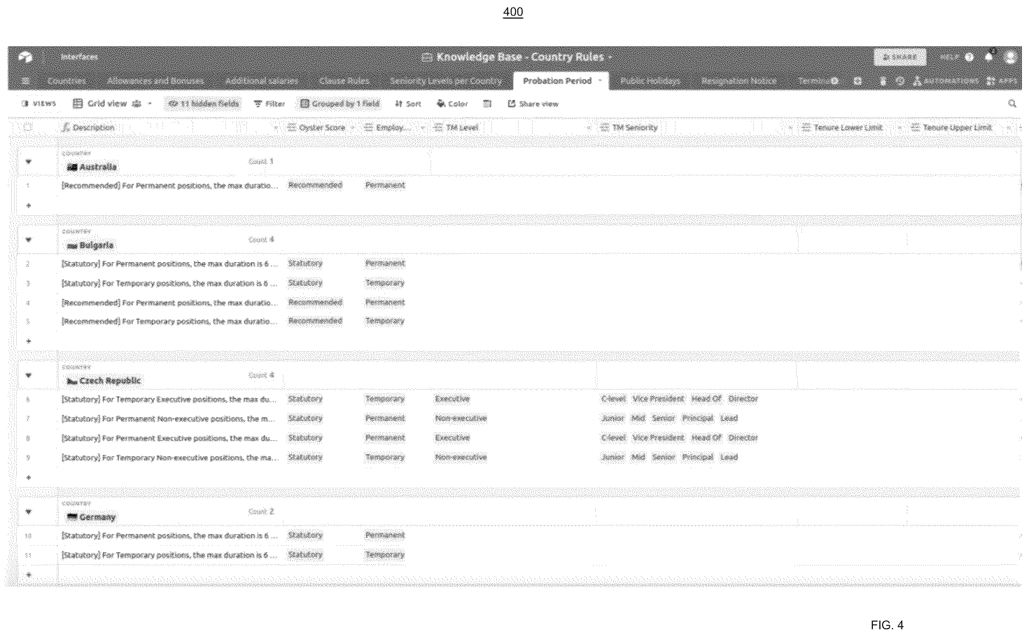

FIG. 4 depicts an exemplary dynamic dashboard for a declarative knowledge base 400 according to an embodiment of the present disclosure. The declarative knowledge base 400 may be a decision table input tool modified by users operating agent device(s) 104 to update, add, or remove, existing employment regulatory laws for specific geographic regions. As depicted, declarative knowledge base 400 may be a dashboard hosted by server system 106 and may be in further communication with database(s) 108.

The declarative knowledge base 400 may display one or more view/perspectives that enable users to update the data/knowledge that is maintained. For example, declarative knowledge base 400 may be configured to display an integrated view of a decision table, a decision tree representation of updates, and prose generated from the underlying data (e.g., data-to-text component).

Although the dashboard of declarative knowledge base 400 is depicted in FIG. 4, it may be coded in a declarative approach that optimizes code maintenance, code updates, code reusability, and data flow transparency, such that data (i.e., the collective employment law knowledge of computing environment 100) can be expressed as business rules. To enable such functionality, server system 106 may employ a fully declarative API that is in communication with a dashboard of declarative knowledge base 400. This infrastructure may be configured to maintain the full spectrum of global employment knowledge with one codebase that is able to dynamically represent and validate complex conditional logic and workflows.

Further, the infrastructure associated with declarative knowledge base 400 may be intelligent, in that it can understand the decision tree it is dealing with, and therefore it can also understand the data the tree needs in order to bind its nodes. For example, when the system identifies the data it needs to bind the tree, it can then construct any kind of interface or service it needs to get that data in any order, form, or grouping that makes sense, at any time inside or outside of the workflow. Such an infrastructure can also be used to guide a user when there is missing data or give them the opportunity to start workflows based on their data's readiness. For example, forms on the SAGE platform may be configured to prompt a user for the specific data needed for each country, with its specific rules, for the system to fully evaluate the tree and generate hiring contracts. In this non-limiting example, one having skill in the art will appreciate that choosing a root node is (e.g., hire full time employee in country “X”) and the responsive binding/refining of the decision is driven by a runtime interpreter that knows how to read the data in the codebase. Here, each point in the workflow may be represented as a set of bound points in the decision tree, with specific directional instructions to bind the nodes that lead to the next step in the workflow.

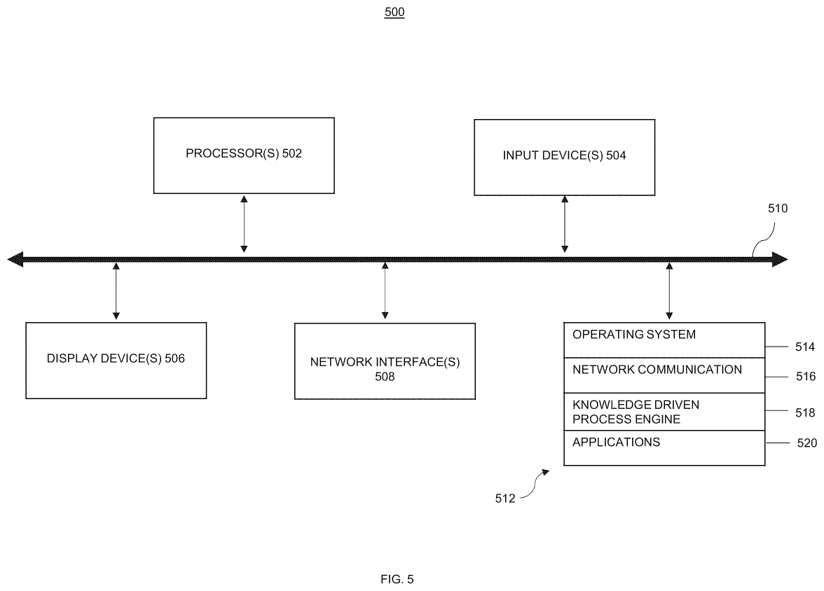

FIG. 5 depicts an exemplary computing device according to an embodiment of the present disclosure. For example, in some embodiments the computing device 500 may function as the user device(s) 102, or agent device(s) 104, and/or server system 106 or a portion of any of these elements. The computing device 500 may be implemented on any electronic device that runs software applications derived from instructions, including without limitation personal computers, servers, smart phones, media players, electronic tablets, game consoles, email devices, etc. In some implementations, the computing device 500 may include processor(s) 502, one or more input device(s) 504, one or more display device 506, one or more network interfaces 508, and one or more computer-readable medium 512. Each of these components may be coupled by a bus 510.

The display device 506 may be any known display technology, including but not limited to display devices using Liquid Crystal Display (LCD) or Light Emitting Diode (LED) technology. The processor(s) 502 may use any known processor technology, including but not limited to graphics processors and multi-core processors. The input device(s) 504 may be any known input device technology, including but not limited to a keyboard (including a virtual keyboard), mouse, track ball, and touch-sensitive pad or display. The bus 510 may be any known internal or external bus technology, including but not limited to ISA, EISA, PCI, PCI Express, USB, Serial ATA, or FireWire. The computer-readable medium 512 may be any non-transitory medium that participates in providing instructions to the processor(s) 502 for execution, including without limitation, non-volatile storage media (e.g., optical disks, magnetic disks, flash drives, etc.), or volatile media (e.g., SDRAM, ROM, etc.).

The computer-readable medium 512 may include various instructions for implementing an operating system 514 (e.g., Mac OS®, Windows®, Linux, iOS, Android). The operating system may be multi-user, multiprocessing, multitasking, multithreading, real-time, and the like. The operating system may perform basic tasks, including but not limited to: recognizing input from the input device(s) 504; sending output to the display device 506; keeping track of files and directories on the computer-readable medium 512; controlling peripheral devices (e.g., disk drives, printers, etc.) which can be controlled directly or through an I/O controller; and managing traffic on the bus 510. The network communications instructions 516 may establish and maintain network connections (e.g., software for implementing communication protocols, such as TCP/IP, HTTP, Ethernet, telephony, etc.).

The SAGE engine 518 may include instructions that enable computing device 500 to implement one or more methods as described herein. Applications 520 may be an application that uses or implements the processes described herein and/or other processes. The processes may also be implemented in the operating system 514. For example, applications 520 and/or operating system 514 may execute one or more operations to implement decision tree related processes.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java, python, and the like), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed is:

1. A system comprising:
one or more processors implementing instructions for:
generating a decision tree comprising one or more nodes;
receiving a selection related to an employment inquiry;
receiving a selection of a geographical preference associated with the employment inquiry;
modifying the decision tree such that the one or more nodes are limited to a subset of nodes related to the employment inquiry and the geographical preference;
receiving a selection of a preferred node of the subset of nodes; and
modifying the decision tree such that the decision tree is limited to the preferred node and a corresponding at least one branch.

2. The system of claim 1, further comprising a declarative knowledge base configured to receive data input via a decision table.

3. The system of claim 1, further comprising declarative application programming interface.

4. The system of claim 1, wherein modifying the decision tree such that the decision tree is limited to the preferred node, further comprises removing or greying out unrelated nodes and branches.

5. The system of claim 1, wherein modifying the decision tree such that the decision tree is limited to the preferred node, further comprises removing or greying out unrelated nodes and branches.

6. The system of claim 1, wherein a dynamic dashboard is configured to prompt a user for the specific data needed for the employment inquiry.

7. The system of claim 1, wherein a declarative knowledge base includes is configured to identify data it needs to response to the employment inquiry and further responsively modify a dynamic dashboard to prompt a user for the data.

8. A computer-implemented method for:
generating a decision tree comprising one or more nodes;
receiving a selection related to an employment inquiry;
receiving a selection of a geographical preference associated with the employment inquiry;
modifying the decision tree such that the one or more nodes are limited to a subset of nodes related to the employment inquiry and the geographical preference;
receiving a selection of a preferred node of the subset of nodes; and
modifying the decision tree such that the decision tree is limited to the preferred node and a corresponding at least one branch.

9. The computer-implemented method of claim 8, further comprising receiving data input via decision table, wherein the data input modifies a declarative knowledge base.

10. The computer-implemented method of claim 8, further comprising wherein the decision tree is dynamically modified based at least on calls received via declarative application programming interface.

11. The computer-implemented method of claim 8, further comprising declarative application programming interface.

12. The computer-implemented method of claim 8, wherein modifying the decision tree such that the decision tree is limited to the preferred node, further comprises removing or greying out unrelated nodes and branches.

13. The computer-implemented method of claim 8, wherein modifying the decision tree such that the decision tree is limited to the preferred node, further comprises removing or greying out unrelated nodes and branches.

14. The computer-implemented method of claim 8, wherein a dynamic dashboard is configured to prompt a user for the specific data needed for the employment inquiry.

15. The computer-implemented method of claim 8, wherein a declarative knowledge base includes is configured to identify data it needs to response to the employment inquiry and further responsively modify a dynamic dashboard to prompt a user for the data.

16. A non-transitory computer-readable medium storing instruction that when implemented cause one or more processors to:
generate a decision tree comprising one or more nodes;
receive a selection related to an employment inquiry;
receive a selection of a geographical preference associated with the employment inquiry;
modify the decision tree such that the one or more nodes are limited to a subset of nodes related to the employment inquiry and the geographical preference;
receive a selection of a preferred node of the subset of nodes; and
modify the decision tree such that the decision tree is limited to the preferred node and a corresponding at least one branch.

17. The non-transitory computer-readable medium of claim 16, further storing instructions that cause the one or more processors to receive data input via decision table, wherein the data input modifies a declarative knowledge base.

18. The non-transitory computer-readable medium of claim 16, further storing instructions that cause the one or more processors to dynamically modify a decision tree based at least on calls received via declarative application programming interface.

19. The non-transitory computer-readable medium of claim 16, further storing instructions that cause the one or more processors to modify the decision tree such that the decision tree is limited to the preferred node, further comprises removing or greying out unrelated nodes and branches.

20. The non-transitory computer-readable medium of claim 16, further storing instructions that cause the one or more processors to prompt a user for the specific data needed for the employment inquiry.
